(19) United States
(12) Patent Application Publication
(10) Pub. No.: US 2008/0064774 A1
(43) Pub. Date: Mar. 13, 2008

(54) Stabilized extruded alkenyl aromatic polymer foams and processes for extruding stabilized alkenyl aromatic polymer foams

(76) Inventor: William G. Stobby, Midland, MI (US)

Correspondence Address: The Dow Chemical Company, Intellectual Property Section, P.O. Box 1967, Midland, MI, 48641-1967, US

(21) Appl. No.: 11/897,800

(22) Filed: Aug. 31, 2007

Related U.S. Application Data
(60) Provisional application No. 60/842,819, filed on Sep. 7, 2006.

(51) Int. Cl. C08J 9/228

(52) U.S. Cl. 521/79

(57) ABSTRACT

Prepare an extruded thermoplastic polymer foam having less 1000 parts per million, based on total polymer weight, of cations from water soluble salts that exist or form into a solid or glassy state that is less malleable than the thermoplastic polymer as the foamable composition exits an extrusion die during foam manufacturing using a brominated flame retardant, an innocuous stabilizer and a blowing agent containing water.

### CROSS REFERENCE STATEMENT

This application claims the benefit of U.S. Provisional Application No. 60/842,819 filed Sep. 7, 2006.

### FIELD OF THE INVENTION

The invention relates to stabilized extruded alkenyl aromatic polymer foams and to processes for extruding stabilized alkenyl aromatic polymer foams.

### BACKGROUND OF THE INVENTION

In 2010, emissions standards in the United States and in Europe are expected to become more stringent. One area that will be affected by these new standards is the production of alkenyl aromatic polymer foams and the resulting foam products. Such foams, as well as the processes for making them, must comply with these standards while also complying with flame retardant related standards and thermal conductivity requirements with respect to insulation applications. One aspect of producing these foams that will be particularly affected is the selection of a blowing agent. To comply with emission standards, many of the blowing agents that are currently used, particularly hydrochlorofluorocarbons (HCFCs) will likely not be available. Therefore, substitutions or replacements for these compounds in blowing agents will be required. The most desirable blowing agent systems would comprise a substantial amount of water and/or carbon dioxide (CO₂).

Flame retardants are necessary additives in the production of alkenyl aromatic polymer foams in order to produce foams that pass required fire standards. These flame retardants have typically contained bromine. Hexabromocyclododecane (HBCD) is generally used in the extruded polystyrene foam industry because it has the most favorable combination of cost and performance of such additives currently available.

In addition to brominated flame retardants, stabilizers are also typically employed to protect the flame retardants from extensive decomposition during the extrusion process by which extruded foam is made.

It is desirable to prepare an extruded polymeric foam using a brominated flame retardant in combination with water as a blowing agent component and in order to obtain a foam using an environmentally friendly blowing agent and that achieves necessary flame retardant properties.

### SUMMARY OF THE INVENTION

This invention is the result of discovering that extrusion processes for thermoplastic polymer foam using water as a blowing agent, a brominated flame retardant and conventional stabilizers develop problems with surface defects on the foam as it exits the extrusion die. Such surface defects take the form of lines, cuts, fractures or other irregularities extending in the extrusion direction along a primary surface of the foam. Such surface defects are undesirable. Research in developing the present invention required discovering the cause for these surface defects and discovering a method for avoiding them.

The surface defects were unexpectedly and surprisingly found to result from build-up of water soluble salts that, under the conditions at the extrusion die lip, are in a solid state and less malleable than the expanding polymer. Analysis of the salts revealed that they tend to be reaction byproducts from combining brominated flame retardants with conventional flame retardant stabilizers. The salts are carried to the die lip by water. The water flashes off at the die lip leaving the salts behind.

The present invention provides a novel and inventive solution to the problem of surface defects in extruded foam caused by the previously unexpected build up of water soluble salts on the die lip of the extrusion equipment.

In a first aspect, the present invention is a process for extruding a thermoplastic polymer foam comprising the steps of: (a) providing a foamable composition comprising a thermoplastic polymer, a blowing agent that includes water, a brominated flame retardant and a stabilizer in an extrusion die at an initial temperature that exceeds the softening point of the thermoplastic polymer and at an initial pressure sufficient to preclude foaming; (b) extruding the foamable composition through an extrusion die and out from an extrusion die lip to an environment at a pressure and temperature lower than the initial temperature and pressure; and (c) allowing the foamable composition to expand into a polymeric foam; wherein the foamable composition contains, based on total thermoplastic polymer weight, 1000 parts per million or less of cations from water soluble salts that exist or form into a solid or glassy state that is less malleable than the thermoplastic polymer as the foamable composition exits the extrusion die.

Particular embodiments of the first aspect include one or any combination of more than one of the following additional characteristics: the foamable composition contains, based on total thermoplastic polymer weight, 150 parts per million or less of cations from water soluble salts that exist or form into a solid or glassy state that is less malleable than the thermoplastic polymer as the foamable composition exits the extrusion die; the stabilizer is an innocuous stabilizer; the stabilizer is at least one compound selected from a group consisting of innocuous acid scavengers, innocuous allylophilic organotin compounds and innocuous dieneophilic organotin compounds; the concentration of stabilizer is present at concentration of 30 weight-percent or less based on brominated flame retardant weight; the stabilizer includes at least one innocuous acid scavenger; the innocuous acid scavenger is selected from a group consisting of epoxy containing organic compounds, polyhydroxyl compounds, hydrocalumite, hydrotalcite and hydrotalcite-like clays; the stabilizer is selected from hydrotalcite and hydrotalcite-like clays; the stabilizer includes at least one organotin compound selected from innocuous allylophilic organotin compounds and dienophilic organotin compounds; the organotin compound is selected from a group consisting of alkyl tin thioglycolates, alkyl tin mercatopropionates, alkyl tin mercaptides, alkyl tin maleates and alkyl tin di(alkylmaleates) wherein the alkyls are selected from methyl-, butyl- and octyl-groups; the concentration of water is at least 0.15 parts per hundred based on polymer weight; and the thermoplastic polymer comprises one or a combination of more than one alkenyl aromatic polymer.

In a second aspect, the present invention is an extruded thermoplastic polymer foam comprising a thermoplastic polymer composition having defined therein multiple cells, the thermoplastic polymer foam containing at least one thermoplastic polymer, a brominated flame retardant and containing 1000 parts per million or less, based on total polymer weight, of cations from water soluble salts that exist or form into a solid or glassy state that is less malleable than the thermoplastic polymer as the foamable composition exits an extrusion die during foam manufacturing.

Particular embodiments of the second aspect include one or any combination of more than one of the following additional characteristics: the foam contains at least one innocuous stabilizer; the foam contains a stabilizer selected from a group consisting of innocuous acid scavengers, innocuous allylophilic organotin compounds and innocuous dieneophilic organotin compounds; the stabilizer includes at least one innocuous acid scavenger; the innocuous acid scavenger is selected from a group consisting of epoxy containing organic compounds, polyhydroxyl compounds, hydrocalumite, hydrotalcite and hydrotalcite-like clays; the stabilizer includes at least one innocuous organotin compound selected from innocuous allylophilic organotin compounds and dienophilic organotin compounds; the organotin compound is selected from a group consisting of alkyl tin thioglycolates, alkyl tin mercatopropionates, alkyl tin mercaptides, alkyl tin maleates and alkyl tin di(alkylmaleates) wherein the alkyls are selected from methyl-, butyl- and octyl-groups; and the thermoplastic polymer comprises one or a combination of more than one alkenyl aromatic polymer.

The invention is useful for preparing extruded thermoplastic foams containing brominated flame retardant using water as a blowing agent. In particular, the invention is useful for preparing such an extruded thermoplastic foam that has a defect-free surface and that contains brominated flame retardant using water as a blowing agent.

### DETAILED DESCRIPTION OF THE INVENTION

“Stabilizer” refers to a compound that inhibits accelerated decomposition of a flame retardant. Brominated flame retardants having a β-hydrogen tend to decompose at elevated temperatures by evolution of hydrobromic acid (HBr) and formation of a double bond between adjoining carbon atoms. Once a double bond is present, loss of subsequent HBr molecules can be accelerated by the presence of acid as well as any propensity for the flame retardant to develop conjugated double bonds. A stabilizer counteracts the effect of the HBr, the flame retardant's propensity to form conjugated double bonds, or both.

“Substantially free” means that the referenced compound is present in amounts of less than 300 ppm, preferably less than 200 ppm and more preferably less than 100 ppm based on weight of polymer.

“Softening point” of a polymer refers to the temperature at which the polymer may be extruded and blended with other components. Typically, the softening point of an amorphous polymer is at or about its glass transition temperature (Tg). The softening point of a crystalline, or semi-crystalline polymer is typically at or about its melt temperature (Tm).

A “water soluble” salt has a solubility in water of at least 0.5 wt % at 20° C., meaning at least half of one gram of salt will dissolve in 100 grams of water. Even more troublesome are water soluble salts having a water solubility of at least one wt % at 20° C.

“Die lip” refers to the portion of die channel at the exit opening of an extrusion die. In an extrusion die, the die lip is the last portion of the die that a polymer composition contacts prior to exiting a die. Die lip and extrusion die lip are interchangeable herein.

“Die approach” refers to a portion of a die channel just prior to the die lip. The die channel is the portion of the die through with foamable composition travels during extrusion.

“Malleable” refers to the ability of a material to deform under pressure.

Unless otherwise stated “pph” refers to “weight parts based on 100 weight parts polymer.”

Suitable thermoplastic polymers for use in the present invention include one or a combination of more than one alkenyl aromatic polymer and/or copolymer, ethylene-based polymer and/or copolymers, propylene based polymer and/or copolymer, and polyvinyl chloride based polymer and/or copolymer.

Desirably, the thermoplastic polymer is or contains at least one alkenyl aromatic polymer, alkenyl aromatic copolymer or blend of at least one alkenyl aromatic polymer and at least one alkenyl aromatic copolymer. A preferred such alkenyl aromatic polymer is polystyrene and preferred alkenyl aromatic copolymers are copolymers of styrene with acrylonitrile, maleic anhydride, acrylic or methacrylic acid or the alkyl esters thereof, including 2-hydroxyethyl acrylate or methacrylate. Copolymers of styrene and acrylonitrile and blends of these copolymers and blends of these copolymers with polystyrene are particularly preferred.

The brominated flame retardant can be aliphatic or aromatic. Aliphatic bromine compounds are preferred over aromatic bromine compounds because the aromatic bromine compounds are often too stable to degrade in a temperature range necessary to be optimal flame retardants in polymer foams. Aliphatic bromine compounds tend to have sufficient stability to survive an extrusion process, but degrade at a sufficiently low temperature to behave a flame retardants in polymer foams. Examples of preferred compounds include cycloaliphatic bromine compounds such as hexabromocyclododecane (HBCD) (e.g. CD-75P, commercially available from Chemtura Corp.); hexabromo-2-butene; 1,1,1,3-tetrabromononane; tetrabromocyclooctane (BC-48, commercially available from Albemarle Corporation); 1,2-dibromo-4-(1,2-dibromoethyl)cyclohexane; dibromoethyldibromocyclohexane (BCL-462, commercially available from Albemarle Corporation); dibromomethyl dibromocyclopentane; pentabromomonochlorocyclohexane (FR-651A); hexabromocyclohexane; and, tetrabromotrichlorocyclohexane and other aliphatic compounds such as 8,9,11,12,14,15-hexabromostearic acid or 2,3-dibromopropyl functionalized compounds such as tris(2,3-dibromopropyl)isocyanurate (FR-930 from Akzo Nobel); tetrabromobisphenol S bis(2,3-dibromopropyl ether) (Nonnen 52 from Marubishi Oil Co.); bis(2,3-dibromopropyl ether) of tetrabromobisphenol A (PE-68 from Chemtura Corp.), and the like. Other examples of aliphatic flame retardants include the halogenated phosphate esters exemplified by tris(tribromoneopentyl)phosphate (PB-370), dibromoneopentylglycol, and tribromoneopentylalcohol, trischloropropyl phosphate, tris(dichloropropyl)phosphate (TDCP), and ethylene bis(dibromomonoborane)dicarboximide (BN-451). Another example of a bromine containing flame retardant is melamine hydrobromide (MBR-40 from Montedison).

Another preferred brominated flame retardant comprises a thermally stable brominated copolymer, the copolymer having polymerized therein a butadiene moiety and a vinyl aromatic monomer moiety, the copolymer having, prior to bromination, a vinyl aromatic monomer content of from 5 wt % to 90 wt %, based upon copolymer weight, a 1,2-butadiene isomer content of greater than 0 wt %, based upon butadiene moiety weight, and a weight average molecular weight of at least 1000, the brominated copolymer having an unbrominated, non-aromatic double bond content of less than 50 percent, based upon non-aromatic double bond content of the copolymer prior to bromination as determined by ¹H NMR spectroscopy and a five percent weight loss temperature (5% WLT), as determined by thermogravimetric analysis (TGA) of at least 200 degrees centigrade (° C.). These brominated copolymers are described in U.S. Provisional Application No. 60/735,361, filed on Nov. 12, 2005, which is herein incorporated by reference in its entirety.

The brominated flame retardants are typically present in an amount of at least 0.2 pph, preferably at least 0.35 pph and more preferably at least 0.8 pph, preferably up to 1.2 pph and more preferably up to 4 pph.

The blowing agent for use in the present invention comprises water and desirably at least one blowing agent selected from hydrocarbons, hydrofluorocarbons and fluorocarbons. Water is typically present in an amount greater than 0.15 pph, preferably greater than 0.5 pph, more preferably greater than 0.7 pph and still more preferably greater than 1.0 pph, and typically present at a concentration up to an amount of 5 pph, preferably up to 2.5 pph and more preferably up to 1.6 pph. The use of water in the present invention allows lower process pressures, lower foam density, and larger cell size all while being an environmentally friendly blowing agent. Suitable hydrocarbons include, but are not necessarily limited to, hydrocarbons having from one to five carbons (“C₁₋₅ hydrocarbons”). The hydrocarbon is preferably selected from the group consisting of isobutane, cyclopentane, n-pentane, isopentane and combinations thereof. Other useful co-blowing agents include but are not limited to ethers having from two to five carbons, alcohols, alkyl formates and ketones. Suitable hydrofluorocarbons may include any hydrofluorocarbon, but are preferably selected from the group consisting of 1,1,1,2-tetralfluoroethane (HFC-134a); HFC-235fa; 1,1,1,3,3-pentafluoropropane (HFC-245fa); 1,1,1,3,3-pentafluorobutane (HFC-365mfc); 1,1-difluoroethane (HFC-152a) and combinations thereof. The hydrocarbon is typically present in an amount up to 6 pph, preferably in an amount up to 4 pph, and more preferably in an amount up to 2 pph. The hydrofluorocarbon is typically present in the range of from 0 pph to 10 pph, preferably in the range of from 2.0 pph to 8 pph, and more preferably in the range of from 3.0 pph to 7.5 pph. Other suitable components for the blowing agent include carbon dioxide and ethanol.

Blowing agent is typically present at a concentration of at least 0.05 moles, preferably at least 0.07 moles and typically 0.2 moles or less, preferably 0.16 moles per 100 grams of polymer.

Suitable stabilizers for use in the present invention are “innocuous” stabilizers. Determine whether a stabilizer is “innocuous” by combining the stabilizer with hexabromocyclododecane (HBCD) at a 1:100 weight ratio (stabilizer-to-HBCD) and then heat to 220° C. in a sealed container for one hour. If less than 7000 ppm of water extractable cations, based on a combined weight of HBCD and stabilizer, is present after heating then the stabilizer is an “innocuous” stabilizer. Desirably, an innocuous stabilizer will produce 6000 ppm or less, preferably 2000 ppm or less, more preferably 1000 ppm or less, even more preferably 100 ppm or less, still more preferably 50 ppm or less water extractable cations under these test conditions. Some embodiments of innocuous stabilizers will produce 10 ppm or less or even one ppm or less water extractable cations under these test conditions. Herein, water extractable salts are the same as water soluble salts. Desirably, the innocuous stabilizer does not react with the components of a foamable composition within the scope of the present invention to produce any water soluble salts. Measure the concentration of water extractable cations by digesting the resulting products after heating using sulphuric acid to remove organic components, then quantitatively extracting the resulting material with water and analyzing the water extract by inductively coupled plasma emissions spectrometry (ICP).

Innocuous stabilizers include innocuous acid scavengers, innocuous allylophilic organotin compounds and innocuous dieneophilic organotin compounds.

Innocuous acid scavengers stabilize brominated flame retardants by reacting with acids that may catalyze the decomposition of the brominated flame retardant. For example, an innocuous acid scavenger reacts with HBr byproduct from decomposition of a brominated flame retardant thereby interfering with the ability of the HBr to catalyze further decomposition of the brominated flame retardant.

Innocuous acid scavengers may be either organic acid scavengers or inorganic acid scavengers. Suitable organic acid scavengers for use as innocuous acid scavengers include epoxy containing organic compounds and polyhydroxyl compounds.

Most epoxy containing organic compounds are considered suitable as organic acid scavengers but some epoxy containing compounds are more desirable. For example, brominated aromatic epoxy resins are preferable due to their low plasticization potential. Examples of such resins include, but are not limited to, epoxy resins based on tetrabromobisphenol A, such as F2200HM (ICL Industrial Products) and DEN 439 (The Dow Chemical Co.). Non-brominated novolak based epoxy resins can also be utilized such as Araldite ECN-1273 or ECN-1280, (Huntsman Advance Materials Americas, Inc.). Useful aliphatic epoxy materials include propylene oxide and aliphatic based epoxy resins, for example, Plaschek 775 aliphatic epoxy resin (Ferro Chemical Co). Propylene oxide offers the advantage of being soluble in the water and offers the potential to neutralize any water extracted hydrobromic acid. Organic acid scavengers are typically present in an amount up to 30 wt %, preferably in an amount up to 15 wt %, and more preferably in an amount up to 8 wt % based on the weight of the halogenated flame retardant. Desirably, if present, the organic acid scavengers are present at a concentration of at least one wt % based on the weight of the halogenated flame retardant.

Polyhydroxyl compounds that are suitable as innocuous acid scavengers include compounds containing at least one hydroxymethyl groups bonded to a common carbon atom or to two adjacent carbon atoms. Preferred such compounds are pentaerythritol or dipentaerythritol ether or low molecular weight, less than about 1000 g/mol, hydrolyzed polycarbohydrate products such as glycerol, xylitol, sorbitol or manitol. These polyhydroxyl compounds could also be derivatized so that a portion of the available hydroxyl groups have been converted to ester groups using fatty acids. Exemplary fatty acids include, but are not limited to, stearic acid, oleic acid and laurylic acid. These compounds are typically present in amounts up to 10 wt %, preferably in amounts up to 5 wt %, and more preferably in amounts up to 2 wt %, based on weight of halogenated flame retardant. Preferably, these compounds are present in amounts of at least 1 wt % based on weight of halogenated flame retardant.

The alkenyl aromatic polymer composition may also or alternatively comprise at least one inorganic acid scavenger. Suitable inorganic acid scavengers include hydrocalumite (general formula, [Ca₂Al(OH)₆]CO₃.zH₂O); hydrotalcite and hydrotalcite-like clays. Preferably the inorganic water insoluble acid scavenger is a hydrotalcite or hydrotalcite-like clay. An inorganic acid scavenger is typically present in an amount up to 30 wt %, preferably in an amount up to 15 wt %, more preferably in an amount up to 10 wt %, based on the weight of the halogenated flame retardant. Preferably, the inorganic acid scavenger is present in an amount of at least one wt % and more preferably in an amount of at least 5 wt %, based on the weight of the halogenated flame retardant.

Suitable hydrotalcites for use as inorganic acid scavengers include those having the general formula: M²⁺₁₋ₓM³⁺ₓ(OH)₂(Aⁿ⁻)_{x/n}mH₂O wherein M²⁺ is selected from the group consisting of Mg²⁺, Ca²⁺, Sr⁺, Ba²⁺, Zn²⁺, Cd²⁺, Pb²⁺, Sn²⁺, or Ni²⁺; M³⁺ is selected from the group consisting of Al³⁺, B³⁺ or Bi³⁺; Aⁿ⁻ is an anion having a valence of n, preferably selected from the group consisting of OH⁻, Cl⁻, Br⁻, I⁻, ClO₄⁻, HCO₃⁻, CH₃COO⁻, C₆H₅COO⁻, CO₃²⁻, SO₄²⁻, (COO⁻)₂, (CHOH)₄CH₂OHCOO⁻, C₂H₄(COO)₂²⁻, (CH₂COO)₂²⁻, CH₃CHOHCO⁻, SiO₃²⁻, SiO₄⁴⁻, Fe(CN)₆³⁻, Fe(CN)₆⁴⁻ or HPO₄²⁻; n is from about 1 to about 4; x is from about 0 to about 0.5; and m is from about 0 to about 2. Preferably, x is a number from 0 to 0.5, and m is a number from 0 to 2. Examples of commercially available hydrotalcites or hydrotalcite-like compounds suitable as inorganic acid scavengers include DHT-4A, DHT-4C and DHT-4V (Kyowa Chemical Industry Co., Ltd.), and Hysafe 539 and Hysafe 530 (J. M. Huber Corporation).

Suitable organotin stabilizers are described in Chapter 3.2.2.1 of the Plastic Additives Handbook, 5^{th} Edition, edited by H. Zweifel (incorporated herein by reference). Organotin stabilizers suitable for use in the present invention fall into two categories: innocuous allylophilic organotin compounds and innocuous dieneophilic organotin compounds. Allylophilic organotin stabilizers stabilize brominated flame retardants from accelerated decomposition by reacting with allyl functionalities that form when a brominated flame retardant loses HBr. By reacting with the allyl functionality, the propensity for the flame retardant to lose additional HBr to obtain conjugation is eliminated. Similarly, dienophilic organotin stabilizers react by means of a Diels Alder reaction with dienes formed when a brominated flame retardant loses two adjacent HBr to form a conjugated diene. By reacting with the diene functionality, the propensity for the flame retardant to lose additional HBr to obtain further conjugation is eliminated.

Examples of suitable organotin stabilizers include organotin compounds selected from a group consisting of alkyl tin thioglycolates, alkyl tin mercaptopropionates, alkyl tin mercaptides, alkyl tin maleates and alkyl tin di(alkylmaleates) wherein the alkyls are selected from methyl-, butyl- and octyl-groups. Commercial examples of such compounds include Thermchek® 832 (Ferro Corporation) and Thermolite 400 (Arkema Inc.), Baerostab M36 (Baerlocher GmbH). The amount of organotin stabilizer is typically in the range of from 0.1 wt % to 10 wt %, preferably 1 wt % to 3 wt %, and more preferably in the range of from 1.5 wt % to 2.5 wt % based on the weight of halogenated flame retardant.

Of particular surprise, organotin stabilizers at levels greater than or equal to 1.0 wt % in the halogenated flame retardant have been shown in the present invention to allow use of barium stearate without undesirable buildup of barium bromide salts on the die face at an extruder discharge gel temperature around 220° C. The terms “undesirable buildup” or “exhibiting buildup” generally mean buildup of a compound on an extrusion die such that it interferes with the skin quality of the resulting foam. Lower levels of organotin stabilizers may be useful at lower process temperatures.

Anti-oxidant and/or chelant materials may be added as separate components, or as one component that serves as both anti-oxidant and chelant. Anti-oxidants and chelants also qualify as innocuous stabilizers but, if included in the present invention, are used in combination with at least one innocuous acid scavenges, innocuous allylophilic organotin compound and/or innocuous dieneophilic organotin compound. Suitable anti-oxidants are described in Chapter 1.5 of the Plastic Additives Handbook, 5^{th} Edition, edited by H. Zweifel (incorporated herein by reference). Examples of suitable anti-oxidant compounds include, but are not necessarily limited to, the class of phenol based anti-oxidants, also described as hindered phenol anti-oxidants, examples of such are Irganox 1010 and Irganox 1076 (Ciba Specialty Chemicals). Examples of suitable chelants include, but are not necessarily limited to a class of compounds described as 1,2-dicarbalkoxyhydrazine with an example being 1,2-dicarbethoxyhydrazine (CAS# 4114-28-7). Another class is based on N-substituted derivatives of oxamide (CAS# 471-46-5) with an example being 2,2′-oxamido bis-(2-hydroxyethyl). Examples of one component anti-oxidant/chelants include, but are not necessarily limited to, compounds such as Naugard XL-1 (2,2′-oxamidobis-[ethyl 3-(3,5-di-tert-butyl-4-hydroxyphenyl)propionate]) (Chemtura Corp.) and Irganox MD 1024 (1,2-bis(3,5-di-tert-butyl-4-hydroxyhydrocinnamoyl)hydrazine, Ciba Specialty Chemicals). These components are present in amounts up to 5 wt %, preferably in an amount up to 3 wt %, and more preferably in an amount up to 2.5 wt % based on weight of halogenated flame retardant. Preferably, these components are present in amounts of at least 0.5 wt % and more preferably at least 1.0 wt %, based on weight of halogenated flame retardant. Not wishing to be bound by any particular theory, it is believed that the anti-oxidant prevents oxygen induced degradation of the halogenated flame retardant in the extruder and chelants complexes or traps transition metal ions that are byproducts of corrosion of the metal surfaces of the extrusion system resulting from the hydrogen halide evolution from the halogenated flame retardant.

The composition may further comprise extruder lubricants. In particular, the composition may comprise metal stearates, preferably calcium or barium stearate.

Other common additives may be included in the present invention, including but not limited to, UV stabilizers, metal stabilizers, pigments, nucleating agents, internal process lubricates, plasticizers and IR blockers.

In a conventional extrusion foaming process, polymer components are converted into a polymer melt and a blowing agent, and, if desired, other additives are incorporated into the polymer melt to form a foamable gel. Those of skill in the art understand that the physical properties and the amount of the additive dictate whether the additive can be added directly or needs to first be compacted or compounded and then added. In many cases it is preferred to pre-compound as much of the stabilizer package as possible into a polymer concentrate or compacted particle and then add the material to ensure intimate mixing of all of the additives with the brominated flame retardant. The foamable gel is then extruded through a die and into a zone of reduced or lower pressure that promotes foaming to form a desired product. The reduced pressure is lower than that under which the foamable gel is maintained prior to extrusion through the die. The lower pressure may be atmospheric, superatmospheric or subatmospheric (vacuum), but is preferably at an atmospheric level. A subsequent post-extrusion step to further reduce density is optional, for example, as is taught in EP0268805 (incorporated herein by reference).

Before extruding foamable gel through a die, it is typically cooled from a temperature that promotes melt mixing to a lower, optimum foaming temperature. The gel may be cooled in the extruder or other mixing device or in separate coolers. The optimum foaming temperature typically exceeds the glass transition temperature (T_{g}) of each polymer component. “Near” means at, above, or below and largely depends upon where stable foam exists. The temperature desirably falls within 40° C. above the T_{g}. For foams of the present invention, an optimum foaming temperature can be determined by simple experimentation by one skilled in the art to produce the desired foam with the appropriate density and open cell content.

The blowing agent may be incorporated or mixed into the polymer melt by any means known in the art such as with an extruder, mixer, or blender. The blowing agent is mixed with the polymer melt at an elevated pressure sufficient to prevent substantial expansion of the melt polymer material and to generally disperse the blowing agent homogeneously therein. Water-soluble stabilizers of the invention may be added to the water prior to addition to the polymer melt.

Optionally, a recycle step may be incorporated into the process wherein scrap foam and foam scrap from cutting operations such as edge trimming is recycled back into the foam process after first being reduced to a polymer pellet form using standard plastic recycle compounders. The extrudable composition of the present invention alleviates further build-up of water soluble inorganic by-products produced while stabilizing the halogenated flame retardant in the recycle process and the subsequent re-melting of the recycle pellet in the extruder.

The process parameters may be varied, as would be known by one skilled in the art, to produce foam with the desired cell size and density.

The process of the present invention is useful to produce the foam of the present invention. Foams of the present invention are made by extruding a foamable composition and characteristically contain at least one thermoplastic polymer, at least one brominated flame retardant and contain 1000 ppm or less, preferably 500 or less, more preferably 300 ppm or less, still more preferably 150 ppm or less, even more preferably 50 ppm or less, and can be 10 ppm or less or even 5 ppm or less based on total polymer weight, of cations from water soluble salts that exist or form into a solid or glassy state that is less malleable than the thermoplastic polymer as the foamable composition exits an extrusion die during foam manufacturing. Measure the concentration of cations from water soluble salts by digesting a portion of a foam using sulphuric acid to remove organic components and then quantitatively extracting the resulting material with water and analyzing the water extract by inductively coupled plasma emissions spectrometry (ICP). The thermoplastic polymer, brominated flame retardant and water soluble salts are as described prior for the process of the present invention. The foam will further typically contain stabilizer.

Foams of the present invention typically have a density of at 80 kg/m³ or less, preferably 64 kg/m³ or less, more preferably 48 kg/m³ or less. Additionally, foams of the present invention generally have a density of 20 kg/m³ or more. The density desirably is in a range of from 24 kg/m³ to 48 kg/m³ if the foam is to be used for insulation purposes. If the foam is to be used as billet foam, the range is preferably from 24 kg/m³ to 64 kg/m³, and more preferably from 28 kg/m³ to 37 kg/m³.

Foams of the present invention preferably have a, unimodal cell size distribution and an average cell size in a range from 0.1 mm to 4.0 mm. If the foam is to be used for insulation purposes, the cell sizes are preferably in the range of from 0.1 mm to 0.8 mm, and more preferably 0.1 mm to 0.5 mm. If the foam is to be used as billet foam, the cell sizes are preferably in the range of from 0.5 mm to 4 mm, and more preferably 0.8 mm to 2.5 mm. The open cell content for foams of this invention can be from 0-100% open. Determine average cell size according to ASTM method D3576. For optimum insulation properties the foam desirably contains 30 percent (%) or less, preferably 10% or less, more preferably 5% or less, and most preferably 2% or less open cell content. Measure open cell content according to ASTM method D6226-05.

Foams of the present invention, if desired, may be laminated to similar foam materials, to films or to rigid facers. Examples of useful films include, but are not limited to those found in U.S. Pat. No. 5,695,870 and U.S. Pat. No. 6,358,599, both of which are hereby incorporated by reference in their entirety. Examples of useful rigid facers include, but are not limited to, concrete, steel, aluminum, gypsum board (commonly known as drywall) and other materials commonly known in the construction industry.

The foams resulting from extrusion of the inventive composition may be used in such areas as building foam insulation, both above and below ground applications, as part of walls and roof assemblies, decorative billet applications, pipe insulation and insulated molded concrete foundation applications. Skilled artisans recognize other uses for such foams as well.

The following examples illustrate, but do not in any way limit, the present invention. Arabic numerals represent examples (Ex) of the invention and letters of the alphabet designate comparative examples (Comp Ex). All parts and percentages are by weight unless otherwise stated. In addition, all amounts shown in the tables are based on weight of polymer contained in the respective compositions unless otherwise stated.

### EXAMPLES

### Test Methods

Foam sample density is determined according to ASTM D3575-93, Suffix W, Method A (determine foam volume by linear measurement of a specimen (a 10 centimeter (cm) cross-section that is cut from a foam)), weigh the specimen and calculate apparent density (weight per unit volume)) and foam cell size is determined according to ASTM D3576. Percent open cell content is determined according to ASTM D 6226-98. All of such ASTM procedures being incorporated herein by reference.

### Process #1 Description

A 2.5 in. (63 mm) single screw extruder was used with two additional sequential process zones for mixing and cooling after typical sequential zones for feeding, melting, and metering to prepare polystyrene foams. The extruder also contained a position for blowing agent injection between the metering and mixing zones. After the cooling zone, an adjustable slit die was attached having a die width that may be varied from 1 in to 3 in. The foaming temperature was 132° C. and the polystyrene resin pellet feed rate was 90.1 kg/hr (200 lbs/hour). The resin pellets were fed together with the additives. Table 1 describes the additives. Extruder run conditions were such that the polystyrene mixture gel temperature upon exiting the extruder section was about 220° C.

The temperature profile of the extruder was maintained to assure stable forwarding of the formulation in the extruder and such that the temperature of the last extruder zone was 220° C. The blowing agents, HFC-134a, CO₂ and water, were injected into the mixing zone at a uniform rate in parts by weight per hundred parts by weight of polymer (pph) as shown in Table 2. The cooling zone temperature was reduced and the die block temperature set to 132° C. for foaming.

### Process #2 Description

Process #1 was replicated, but with some changes. A 1.6 in (40 mm) screw type extruder was substituted for the extruder of Process #1, and the resin feed rate was reduced to 60 kg/hr (1321b/hr). As in Process #1, the temperature profile of the extruder was set to achieve an extruder discharge gel temperature of around 220° C.

### Example Compositions

Table 1 shows the components common to Comparative Examples A-F and Examples 1-12 in pph based on 100 pph of polymer.

TABLE 1

| Component | Amount (pph) |
|---|---|
| Hydrofluorocarbon HFC 134a | 7.5 |
| (1,1,1,2 tetrafluoroethane) | |
| CO₂ | 1.2 |
| H₂O | 1.0 |
| Barium Stearate | 0.15 |
| Talc | 0.25 |
| Dowlex 2247G (linear low density | 0.3 |
| polyethylene, The Dow Chemical | |
| Co.) | |
| Copper Phthalocyanine (blue | 0.125 |
| pigment), Blue Conc. 20% in | |
| polystyrene | |

### Table 2 shows additive descriptions for additives listed in Table 3.

TABLE 2

| Additive | Additive Descriptions |
|---|---|
| HBCD | Hexabromocyclododecane, Saytex ® HP 900, Albemarle Corp. |
| FR1206HT | ICL Industrial Products (70/30 blend with HBCD and F2200HM) |
| Saytex ® BC70HS | Albemarle Corp, (blend of HBCD and Zeolite A) |
| SP-75 | Chemtura, (95/5 blend of HBCD and hydrotalcite) |
| TSPP | Tetrasodium pyrophosphate, Thermphos Pyro coarse E 450, |
| | Thermphos International B.V. |
| Organotin carboxylate | Therm-chek ® 832, an oligomeric dibutyl tin carboxylate, Ferro |
| | Corporation |
| Hydrotalcite | DHT4A ®, synthetic hydrotalcite-like compound, |
| or | [Mg4.3Al₂(OH)12.6CO₃-mH₂0], Kyowa Chemical Industry Co., Ltd. |
| hydrotalcite-like | |
| compound | |
| Anti-oxidant/chelant | Naugard ® XL-1, 2,2′-oxamidobis-[ethyl-3-(3,5-di-tert-butyl-4- |
| | hydroxyphenyl) propionate], Chemtura |
| Brominated epoxy resin | F2200HM, epoxy resin based on tetrabromo-bisphenol A, Mw = 700, |
| | Epoxy Eq. Wt = 350, mp = 105-115° C., ICL Industrial Products |
| | (added via a 70/30 weight blend with HBCD - FR1206HT, ICL |
| | Industrial Products) |
| Ortho cresol novolac | Araldite ECN1273, MW = 1090, Epoxy Eq. Wt = 225, mp = 73, |
| epoxy resin | Huntsman Advance Materials Americas Inc. |
| Zeolite A | EZA Zeolite A, Sodium aluminum silicate [(NaAlSiO₄)₁₂•27H₂O], |
| | Albemarle Corp. |

Table 3 shows Example compositions. Resin 1 was a 50/50 weight ratio blend of a poly(styrene-co-acrylonitrile)(SAN) having 16.5 wt % acrylonitrile, weight average molecular weight (M_{w}) of 83,100 and a polydispersity of 2.15; and a SAN having 15 wt % acrylonitrile, weight average M_{w} of 118,000 and a polydispersity of 2.2. Resin 2 was a SAN having 15 wt % acrylonitrile, a weight average M_{w} of 118,000 and a polydispersity of 2.2°. Resin 3 was a 50/50 weight ratio blend of Resin 2 and a SAN having 15 wt % acrylonitrile, weight average M_{w} of 144,000 and a polydispersity of 2.15.

TABLE 3
Example Compositions^{#}

| | | | Organotin | | | | Brominated | Cresol Novolak | |
|---|---|---|---|---|---|---|---|---|---|
| Example | Resin | HBCD | Stabilizer | Hydrotalcite | Anti-oxidant/chelant | Zeolite A | epoxy resin | Epoxy | TSPP |
| A* | 1 | 0.9 | 0 | 0 | 0 | 0 | 0 | 0 | 0.25 |
| B* | 1 | 0.9 | 0 | 0 | 0 | 0 | 0 | 0 | 0.25 |
| C* | 2 | 0.9 | 0.035** | 0 | 0 | 0.035 | 0 | 0 | 0 |
| D* | 2 | 0.9 | 0 | 0.04 | 0 | 0 | 0 | 0 | 0 |
| E* | 3 | 0.8 | 0 | 0 | 0 | 0 | 0 | 0 | 0.05 |
| 1 | 1 | 0.9 | 0.020 | 0.010 | 0.020 | 0 | 0 | 0 | 0 |
| 2 | 2 | 0.9 | 0.012 | 0.006 | 0.012 | 0 | 0.160 | 0 | 0 |
| 3 | 2 | 0.9 | 0.014 | 0.007 | 0.014 | 0 | 0.120 | 0 | 0 |
| 4 | 2 | 0.9 | 0.016 | 0.008 | 0.016 | 0 | 0.080 | 0 | 0 |
| 5 | 2 | 0.9 | 0.02 | 0.01 | 0.02 | 0 | 0 | 0 | 0 |
| 6 | 2 | 0.9 | 0.014 | 0.007 | 0.014 | 0 | 0.160 | 0 | 0 |
| 7 | 2 | 0.9 | 0.012 | 0.006 | 0.012 | 0 | 0 | 0 | 0 |
| 8 | 2 | 0.9 | 0.08 | 0.004 | 0.008 | 0 | 0 | 0 | 0 |
| 9 | 2 | 0.9 | 0.012 | 0.006 | 0.012 | 0 | 0 | 0.10 | 0 |
| 10 | 2 | 1.9 | 0.040 | 0.020 | 0.040 | 0 | 0 | 0 | 0 |
| 11 | 2 | 2.85 | 0.06 | 0.03 | 0.06 | 0 | 0 | 0 | 0 |
| 12 | 3 | 1.19 | 0.025 | 0.012 | 0.025 | 0 | 0 | 0 | 0 |

^{#}Concentrations of additives are shown as by weight based on 100 parts by weight of polymer.
*Comparative, not of the invention.
**Organotin stabilizer structure and supplier unknown.

Table 4 shows foam properties and extrusion results for examples using Resin 1 and Process #1.

TABLE 4
Example Foam Properties and Extrusion Results - Resin 1

| | | | | | | Water |
|---|---|---|---|---|---|---|
| | Cell | | | | | Soluble |
| | Size, | Density, | Open cell | | Die Face | Cations |
| Example | mm | kg/m³ | content, % | Skin Quality Comments | Buildup | in Foam* |
| A | 0.24 | 34.2 | 0.0 | Horizontal cracks on both | Yes | 1080 |
| | | | | primary surfaces | | |
| B | 0.30 | 33.0 | 4.4 | Grooves in extrusion | Yes | N/M |
| | | | | direction on both primary | | |
| | | | | surfaces and some | | |
| | | | | horizontal cracks | | |
| 1 | 0.18 | 37.7 | 0.0 | Excellent | None | 150 |

*values in parts per million based on total thermoplastic polymer weight. N/M = not measured.

As may be seen from Comparative Example A, when the stabilizer consisted of TSPP at 0.25 wt %, the cell size was 0.24 mm, and density was 34.2 kg/m³ (2.11 pcf.) Skin quality was poor with horizontal cracks on both primary surfaces. Example B was a reproduction of Example A and showed small grooves in the extrusion direction on the foam primary surfaces. Die build-up was found for both of these comparative examples.

In contrast, as may be seen in Example 1 of the invention using a preferred blend of organotin stabilizer, hydrotalcite and a combined anti-oxidant/chelant, Naugard XL-1, the cell size was 0.18 mm and the density (w/skin) was 37.7 kg/m³. Skin quality was excellent; no cracks or other skin issues were observed. In addition, no die face buildup was observed.

Table 5 shows foam properties and extrusion results for examples using Resin 2 and Process #1.

TABLE 5
Example Foam Properties and Extrusion Results - Resin 2

| | Cell | | | | Die |
|---|---|---|---|---|---|
| Exam- | Size, | Density, | Open cell | | Face |
| ple | mm | kg/m³ | content, % | Skin Quality Comments | Buildup |
| C | 0.32 | 34.7 | N/A | Cracks and blemishes | Yes |
| | | | | in the extrusion direction | |
| 2 | 0.23 | 33.2 | 0.0 | Some very small | None |
| | | | | horizontal cracks, | |
| | | | | no grooves | |
| | | | | observed | |
| 3 | 0.24 | 33.2 | 3.7 | Excellent | None |
| 4 | 0.26 | 33.7 | 3.6 | Excellent | None |
| 5 | 0.33 | 34.7 | N/A | Excellent | None |
| 6 | 0.26 | 33.7 | N/A | Excellent | None |
| 7 | 0.32 | 34.3 | N/A | Excellent | None |
| 8 | 0.33 | 34.7 | N/A | Good | None |
| 9 | 0.32 | 33.8 | N/A | Excellent | None |
| 10 | 0.25 | 33.7 | N/A | Excellent | None |
| 11 | 0.23 | 31.6 | N/A | Excellent | None |

Comparative Examples C used stabilized HBCD compound Saytex BC-70HS (Albemarle Corporation). Foam properties and extrusion results are shown in Table 4. Example C showed die build-up and poor skin quality in the presence of Zeolite A.

Example 2 used a reduced amount, as compared to Example 1, of the organotin stabilizer. The resulting reduced acid scavenging potential of the organotin was compensated for by using the brominated epoxy resin F2200HM. There were some cracks observed in the skin; however, there was no die face buildup. Observation of the stability of the extruder screw appeared to indicate that the presence of the brominated epoxy resin was causing instability in the forwarding resin, resulting in fluctuations of the extruder discharge pressure. Decreasing the amount of brominated epoxy resin as in Example 3 and Example 4 resulted in improved extruder stability and skin quality.

Example 5 was a reproduction of Example 1, except that the resin used was a more preferred higher molecular weight SAN resin, Resin 2, which provides for larger cell sizes and better skin formation to occur as a result of the ability to use a greater die gap at a given foaming pressure. Example 5 showed no die face build-up or skin quality issues and resulted in a larger cell size.

Example 6 was prepared with the extruder temperature, settings lowered by 10° C. in the forwarding section of the extruder to compensate for the melting characteristics of the F2200HM. The skin quality improved to the desired quality. However, reducing the temperatures in the forwarding sections of a production scale screw is not typically an option without also reducing the feed rate. This can result in difficulties obtaining large foam cross-sections and can also cause economic loss due to reduced production rate and thus is less preferable. The recycle resin from Example 6 was the desired blue color. Example 7 and 8 were prepared at lower levels of the organotin/HDT/Naugard XL1 combination by mixing Example 1 with additional HBCD to determine if sufficient stabilizer system was available to preserve the blue color in the recycle. For Example 7, the recycle resin showed a greenish tint indicating that at the 220° C. extruder conditions, insufficient stabilizer was present. The recycle resin of Example 8 clearly showed a green color. Example 9 was produced with an alternative epoxy resin, Araldite ECN1273 for comparison to Example 6. The lower epoxy equivalent weight allowed for lower quantities to be used and the higher overall molecular weight of the epoxy resin allowed for the addition without any need for adjustment of the extruder set temperatures even though the melting point is lower than F2200HM. The skin quality, density and cell size were acceptable. An additional advantage of a higher molecular weight epoxy resin such as ECN1273 is reduced health and safety concerns such as skin sensitization. The skin quality, density and cell size were acceptable and the recycle resin was blue.

Example 10 and 11 show that acceptable cell size >0.20 mm and skin quality could still be achieved at the higher stabilized HBCD levels that are required for passing other fire tests outside of the United States of America.

### Comparative Example D and Example 12

Foams were produced using Process #1 and Resin 3. Table 6 contains formulation information in addition to that listed in Table 2 for Comparative Example D and Example 12. Table 7 shows the foam characteristics and extrusion results for each example. Each formulation was run for around 6 hours. The resulting foams were large cell size polystyrene foam billets. Comparative Example D and Example 12 demonstrate the usefulness of this invention in producing foam with a cell size greater than 1.6 mm without die face buildup. Extruder exit gel temperature was 200° C. The rate of foam expansion is sufficiently slow when cell sizes greater than 1.0 mm are produced that the presence of die build-up appears to not have a significant impact on skin quality.

TABLE 6

Concentrations*

| Example | D | 12 |
|---|---|---|
| Barium Stearate | 0.05 | 0.05 |
| LLDPE | 0.2 | 0.2 |
| CO₂ | 2.5 | 2.5 |
| H₂O | 1.7 | 1.75 |

*in pph based on weight of 100 parts of polymer

TABLE 7
Example Foam Properties and Extrusion Results - Resin 3

| | Cell | | | | Die |
|---|---|---|---|---|---|
| Exam- | Size, | Density, | Open cell | | Face |
| ple | mm | kg/m³ | content, % | Skin Quality Comments | Buildup |
| D | 2.6 | 27.5 | 2 | Excellent | Yes |
| 12 | 1.8 | 29.5 | 0.7 | Excellent | No |

### Example 13

### Recyclability of the Stabilized Foam of the Invention

Process #2 was used to validate the ability of the stabilizer system of this invention to maintain an acceptable skin quality when recycle is incorporated into the foam formulation. The formulation of Example 6 as given in Table 3 was used for this experiment. The theoretical weight average molecular weight of Resin 3 was 131,000. The blowing agent system was HFC-134a, 7.5 pph; CO₂, 1 pph; and, water, 0.9 pph. A recycle resin was produced to represent the recycle resin produced in a typical extruded polystyrene foam process. The pellet was produced by chopping the foam, reducing the chopped foam to a melt using a densifying extruder, and subsequently chopping the melt to coarse granular product using an underwater die cutter. The resulting wet granulated product was air dried over night and then fed back into the foam extruder and is referred to as “recycle resin”. The formulation utilized 25 wt % of this recycle resin based on the total weight of recycle resin and virgin resin. The amount of additives fed with the virgin resin was adjusted down by 25% to compensate for the additives already in the recycle resin. The chopped foam containing the 25 wt % recycle resin was again processed to obtain a 2^{nd} pass recycle resin. Again, as in above, this 2^{nd} pass recycle resin was added at 25 wt %. Statistically, 6.25 wt % of the original first pass foam produced was contained in the second pass recycle resin pellets and represents the typical steady state conditions of the resin feedstock being used in a typical extruded polystyrene foam plant. Table 8 provides the corresponding weight average molecular weights of the foams and recycle resins and the observations of skin quality.

TABLE 8

| Number of | Foam | Foam | | 1^{st} Pass | 2^{nd} Pass | 3^{rd} Pass | |
|---|---|---|---|---|---|---|---|
| Recycle | Density, | Cell Size | | Recycle | Recycle | Recycle | Skin |
| Passes | kg/m³ | mm | Foam Mw | Resin Mw | Resin Mw | Resin Mw | Quality |
| 1 | 32.4 | 0.27 | 124080 | | | | Excellent |
| 1 | | | | 118570 | | | |
| 2 | 32.6 | 0.23 | 117260 | | | | Excellent |
| 2 | | | | | 108460 | | |
| 3 | 31.6 | 0.28 | 117840 | | | | Excellent |
| 3 | | | | | | 111030 | |

The presence of second pass recycle resin showed no detrimental effect on the foam properties or skin formation even with a molecular weight reduction of approximately 15% as a result of degradation from the starting theoretical molecular weight of Resin 3 which is 131,000. Foam cell size remained acceptable indicating the by-products from stabilizing the HBCD generated by the above stabilizing additives did not cause any additional nucleation.

1. A process for extruding a thermoplastic polymer foam comprising the steps of:
(a) providing a foamable composition comprising a thermoplastic polymer, a blowing agent that includes water, a brominated flame retardant and a stabilizer in an extrusion die at an initial temperature that exceeds the softening point of the thermoplastic polymer and at an initial pressure sufficient to preclude foaming;
(b) extruding the foamable composition through an extrusion die and out from an extrusion die lip to an environment at a pressure and temperature lower than the initial temperature and pressure; and
(c) allowing the foamable composition to expand into a polymeric foam;
wherein the foamable composition contains, based on total thermoplastic polymer weight, 1000 parts per million or less of cations from water soluble salts that exist or form into a solid or glassy state that is less malleable than the thermoplastic polymer as the foamable composition exits the extrusion die.

2. The process of claim 1, wherein the foamable composition contains, based on total thermoplastic polymer weight, 150 parts per million or less of cations from water soluble salts that exist or form into a solid or glassy state that is less malleable than the thermoplastic polymer as the foamable composition exits the extrusion die.

3. The process of claim 1, wherein the stabilizer is an innocuous stabilizer.

4. The process of claim 1, wherein the stabilizer is at least one compound selected from a group consisting of innocuous acid scavengers, innocuous allylophilic organotin compounds and innocuous dieneophilic organotin compounds.

5. The process of claim 4, wherein the concentration of stabilizer is present at concentration of 30 weight-percent or less based on brominated flame retardant weight.

6. The process of claim 1, wherein the stabilizer includes at least one innocuous acid scavenger.

7. The process of claim 6, wherein the innocuous acid scavenger is selected from a group consisting of epoxy containing organic compounds, polyhydroxyl compounds, hydrocalumite, hydrotalcite and hydrotalcite-like clays.

8. The process of claim 1, wherein the stabilizer is selected from hydrotalcite and hydrotalcite-like clays.

9. The process of claim 1, wherein the stabilizer includes at least one organotin compound selected from innocuous allylophilic organotin compounds and dienophilic organotin compounds.

10. The process of claim 9, wherein the organotin compound is selected from a group consisting of alkyl tin thioglycolates, alkyl tin mercaptopropionates, alkyl tin mercaptides, alkyl tin maleates and alkyl tin di(alkylmaleates) wherein the alkyls are selected from methyl-, butyl- and octyl-groups.

11. The process of claim 1, wherein the concentration of water is at least 0.15 parts per hundred based on polymer weight.

12. The process of claim 1, wherein the thermoplastic polymer comprises one or a combination of more than one alkenyl aromatic polymer.

13. An extruded thermoplastic polymer foam comprising a thermoplastic polymer composition having defined therein multiple cells, the thermoplastic polymer foam containing at least one thermoplastic polymer, a brominated flame retardant and containing 1000 parts per million or less, based on total polymer weight, of cations from water soluble salts that exist or form into a solid or glassy state that is less malleable than the thermoplastic polymer as the foamable composition exits an extrusion die during foam manufacturing.

14. The polymer foam of claim 13, further characterized by containing an innocuous stabilizer.

15. The polymer foam of claim 13, further characterized by containing a stabilizer selected from a group consisting of innocuous acid scavengers, innocuous allylophilic organotin compounds and innocuous dieneophilic organotin compounds.

16. The polymer foam of claim 13, wherein the stabilizer includes at least one innocuous acid scavenger.

17. The polymer foam of claim 16, wherein the innocuous acid scavenger is selected from a group consisting of epoxy containing organic compounds, polyhydroxyl compounds, hydrocalumite, hydrotalcite and hydrotalcite-like clays.

18. The polymer foam of claim 15, wherein the stabilizer includes at least one innocuous organotin compound selected from innocuous allylophilic organotin compounds and dienophilic organotin compounds.

19. The polymer foam of claim 18, wherein the organotin compound is selected from a group consisting of alkyl tin thioglycolates, alkyl tin mercatopropionates, alkyl tin mercaptides, alkyl tin maleates and alkyl tin di(alkylmaleates) wherein the alkyls are selected from methyl-, butyl- and octyl-groups.

20. The polymer foam of claim 13, wherein the thermoplastic polymer comprises one or a combination of more than one alkenyl aromatic polymer.
